(19) United States
(12) Patent Application Publication
(10) Pub. No.: US 2011/0233968 A1
(43) Pub. Date: Sep. 29, 2011

(54) TRANSMISSION TUNNEL

(75) Inventors: MARKUS PELLMANN, Sassenberg (DE); Martin Pohl, Altenbeken (DE); Martin Schroeter, Paderborn (DE); Stefan Adelbert, Delbruck (DE); Otto Buschsieweke, Paderborn (DE); Christian Handing, Langenberg (DE)

(73) Assignee: Benteler Automobiltechnik GmbH, Paderborn (DE)

(21) Appl. No.: 13/069,586

(22) Filed: Mar. 23, 2011

(30) Foreign Application Priority Data
Mar. 25, 2010 (DE) 102010012831.7-56

(51) Int. Cl. B62D 25/20

(52) U.S. Cl. 296/193.07

(57) ABSTRACT

A transmission tunnel, in particular for installation in a motor vehicle body, is produced by hot-forming and press-hardening a sheet steel blank, and has a first region which underwent heat treatment, a second region which is not heat-treated, and a transition zone between the first and second regions. The transition zone is hereby defined by a width which is smaller than or equal to 50 mm. At least one component can be coupled to the transmission tunnel to form a floor assembly.

### CROSS-REFERENCES TO RELATED APPLICATIONS

This application claims the priority of German Patent Application, Serial No. 10 2010 012 831.7-56, filed Mar. 25, 2010, pursuant to 35 U.S.C. 119(a)-(d), the content of which is incorporated herein by reference in its entirety as if fully set forth herein.

This is one of five applications all filed on the same day. These applications deal with related inventions. They are commonly owned and have the same inventive entity. These applications are unique, but incorporate the others by reference. Accordingly, the following U.S. patent applications are hereby expressly incorporated by reference: “CROSS MEMBER”, representative's docket no.: PELLMANN-2; “SIDE RAIL”, representative's docket no.: PELLMANN-3; “AUTOMOBILE COLUMN”, representative's docket no.: PELLMANN-5; and “METHOD FOR PRODUCING A MOTOR VEHICLE COMPONENT, AND A BODY COMPONENT”, representative's docket no.: PELLMANN-6.

### BACKGROUND OF THE INVENTION

The present invention relates to a transmission tunnel, and more particularly to a transmission tunnel for installation in a motor vehicle body. The invention also relates to a floor group of a motor vehicle, which includes a transmission tunnel.

It would be desirable and advantageous to provide an improved transmission tunnel which obviates prior art shortcomings and can be produced at low cost in industrial-scale production while still being reliable in operation.

### SUMMARY OF THE INVENTION

According to one aspect of the invention, a transmission tunnel is made of a sheet steel blank and has a first region which underwent heat treatment, a second region which is not heat-treated, and a transition zone between the first and second regions. The transition zone is defined by a width which is smaller than or equal to 50 mm.

According to another aspect of the invention, a floor group of a motor vehicle includes a transmission tunnel and at least one component coupled with the transmission tunnel.

According to another advantageous feature of the present invention, the transmission tunnel can be produced by hot-forming and press-hardening of a steel sheet blank, with the first region undergoing heat treatment after press-hardening.

In accordance with the present invention, the material property in certain regions of the transmission tunnel of the invention can be produced with a reliable process and with desired properties. After hot-forming and press-hardening of a steel sheet blank made from high-strength hardenable steel, a particular area of the transmission tunnel is targeted to undergo a heat treatment. Heat-treating a particular area of the transmission tunnel, will hereinafter also be referred to a “partially” heat-treating or “partial” heat treatment. The heat treatment is carried out below the austenitic transition temperature, so that ductile material structures are produced in the heat-treated regions of the transmission tunnel.

A transmission tunnel according to the invention is integrated in a motor vehicle body centrally in the floor group of the motor vehicle body. The transmission tunnel is integrated through coupling to other components of the floor group, for example floor panels, side rails, cross beams, rocker panels and/or engine supports. As a result, a transmission tunnel is of particular and central importance in the event of a crash. The transmission tunnel is able to safely counter a deformation of the floor group in the event of a crash. Moreover, an intentional deformation can be facilitated by targeted heat treatment in certain regions, without causing the formation of cracks or tearing. The crash energy can then be particularly advantageously converted into deformation energy in these regions of intentional deformation. In addition, coupled add-on components are secured on the transmission tunnel, thereby guaranteeing a strong passenger compartment.

With the transmission tunnel according to the invention, the energy absorption capacity of the entire motor vehicle body is increased while maintaining high stiffness. In a motor vehicle equipped with the transmission tunnel according to the invention, considerable energy is absorbed by converting kinetic energy from the impact into deformation energy while retaining a high stiffness of the passenger compartment.

According to one advantageous embodiment of the transmission tunnel of the invention, due to the regions that remain intentionally unchanged after press-hardening, components of the drive train, of the transmission bell housing and/or of the motor may be prevented from penetrating the motor vehicle body. The high hardness in certain regions attainable in this manner therefore may prevent an undesirable deformation in these regions.

In yet another advantageous feature of the present invention, the width of the transition zone may be less than 30 mm, in particular less than 20 mm. Within the context of the present invention, the transition zone from a heat-treated region to a non-heat-treated region is comparable to a zone affected by heat from a weld seam. Moreover, the material structure is changed in the transition zone which is not necessarily desirable.

According to another advantageous feature of the present invention, a transition zone of less than 15 mm may advantageously be realized on the transmission tunnel. Accordingly, those regions on the individual components, in particular on the transmission tunnel, which are designed to deform in the event of a crash and those regions which can essentially retain their shape in the event of a crash, can already be designated in the manufacture of a crash-optimized motor vehicle body.

In yet another advantageous embodiment, the width of the heat-treated region may correspond to 0.2-times to 3.0-times the width and/or the height of the heat-treated region. In relation to the distribution of the total stress inside the component, a particularly advantageous embodiment for the crash and stiffness structure of the motor vehicle body is attained.

According to another advantageous feature of the present invention, joining flanges may be partially heat-treated. The heat-treated region, in particular embodied as joining flange, is advantageous for the crash property and stiffness of the body, such as an exemplary integral body-frame body. As already described above, parts of the floor assembly, rocker panels, side rails, engine supports and various components for coupling the drive train may be arranged on the joining flanges of a transmission tunnel. The attachment may be produced by gluing, riveting, welding, brazing or similar coupling processes.

The region which has been partially heat-treated does not have a tendency to tear or detach in the event of the accident and therefore holds the surrounding and connected structural and safety-related components together. This is particular advantageous for the stability of the passenger compartment and hence the protection of occupants.

Another advantage relates to regions subjected to an intentional deformation in the event of an accident. The regions defined for intentional deformation can be deformed without tearing. This increases also the overall energy absorption capability of the entire motor vehicle body accompanied by a small penetration depth into the passenger compartment.

According to another advantageous feature of the present invention, due to the intentionally remaining hardened regions, the transmission tunnel may also a high torsional stiffness and connection stiffness and can also hence be used for transmitting large drive forces of a drive train extending, for example, through the transmission tunnel. Another advantage in conjunction with the intentional partial heat treatment is that vibrations in the drive train, for example by stick-slip-behavior of a motor vehicle, can be attenuated to a certain degree as a result of the targeted softer heat-treated regions. This improves the driving comfort due to a reduction of the vibrations of the body.

Another application is, for example, the intentional deformation of individual regions to facilitate lower cost repairs after an accident. This deformation is intended to transfer energy to be dissipated into the body, thereby once more improving the safety for the vehicle occupants in the event of a crash.

The regions heat-treated with the method of the invention may deform in the event of a crash so as to produce intentional wrinkles accompanied by intentional absorption of energy. Additionally, the heat-treated regions tend to form less cracks due to their rather ductile structure compared to the hot-formed and press-hardened, hard and brittle structure.

The partial heat treatment of joining flanges has the additional advantage that the joining flanges have ductile material properties. With a material connection produced by thermal joining, a structural change takes place in a subsequent process in the zone affected by heat generated by the joining method. A ductile section of the transmission tunnel is particularly advantageous for the welding process and the material structure created in the zone affected by heat of the welding process. This is particularly advantageous for the durability of the connected weld seams of the motor vehicle in the event of an accident.

According to another advantageous feature of the present invention, openings in the transmission tunnel may be partially heat-treated. These openings may be incorporated in the component, for example, to reduce weight or for passing through other components, for example a wiring harness or an actuator for seat adjustment and the like. Cracks can form in an accident particularly in the region of the openings and also in the end region of openings due to stress in the components, in particular surface stress, which may extend over the entire component. By reducing the surface stress, a ductile material structure is obtained in this region. This counters the formation of cracks and hence also an easier unintentional deformation of the transmission tunnel.

According to another advantageous feature of the present invention, an end region of the transmission tunnel may be partially heat-treated, wherein a joining flange arranged on the end region is not heat-treated. This has the advantage that when incorporating the transmission tunnel in a motor vehicle body, the heat-treated regions can attenuate loads caused by reverse bending stresses, which may be introduced into the body by, for example, body torsion or other driving parameters, for example drive train vibrations and the like. This has a beneficial effect particularly with respect to the durability of the motor vehicle body by reducing the surface stress in the end regions, positively affecting the required crash properties of the joining flanges connected to the motor vehicle body that are not heat-treated.

According to another advantageous feature of the present invention, spot-shaped regions of the transmission tunnel may be partially heat-treated, wherein the spot-shaped regions have dimensions of less than 50 mm, suitably less than 30 mm. For connecting the transmission tunnel to a motor vehicle body, these spot-shaped regions may be advantageously intentionally heat-treated, thereby allowing spot welding or other local laser welding within the spot-shaped regions of a type frequently performed in the production of motor vehicles. In the event of a motor vehicle crash, the transmission tunnel with the coupled components has again high connection strength in these connected spot-shaped regions. Crack formation or tearing or disconnection is significantly reduced with the heat-treated spot-shaped regions.

According to another advantageous feature of the present invention, the heat-treated regions may have a yield strength between 300 N/mm² and 1300 N/mm², suitably 400 N/mm² to 800 N/mm². Currently preferred is a yield strength of 400 N/mm² to 600 N/mm². In addition, the heat-treated regions may advantageously have a tensile strength between 400 N/mm² and 1600 N/mm², suitably 500 N/mm² to 1000 N/mm². Currently preferred is a tensile strength of 550 N/mm² to 800 N/mm², and advantageously a ductility between 10% and 20%, and suitably 14% to 20%. The material still has the required high-strength mechanical properties; however, due to the reduced tensile strength, elongation limit and the increased ductility the material is sufficiently ductile to produce wrinkles, instead of breaking or tearing, under a suitable load. This advantageously counters potential crack formation in the heat-treated region of the material.

According to another advantageous feature of the present invention, the yield strength and/or tensile strength may decrease in the transition zone from heat-treated region to non-heat-treated region with a gradient of more than 100 N/mm² per 1 cm, suitably of more than 200 N/mm² per 1 cm. Currently preferred is a gradient of more than 400 N/mm² per 1 cm. According to another advantageous feature of the present invention, very small local regions may be heat-treated, whereas the transition zones are kept smaller in relation thereto. The transition zone resulting from the gradient between the hot-formed and press-hardened, non-heat-treated region and the partially heat-treated region has a therefore a dimension of less than 50 mm, currently preferred between 1 mm and 20 mm. This produces small local heat-treated regions with sharp edges and smaller transition zones compared to the heat-treated regions.

According to another advantageous feature of the present invention, the transmission tunnel may be partially heat treated by heating the region to be heat-treated to a heat-up temperature, holding the heat-up temperature during a holding time, and cooling down from the heat-up temperature in at least two phases.

According to another advantageous feature of the present invention, the component may be heated up to and held at the heat-up temperature in a temperature range between 500° C. and 900° C. The temperature range between 500° C. and 900° C. for heat-up and holding the heat-up temperature intentionally and reliably reduces stress in the heat-treated regions during production.

According to another advantageous feature of the present invention, heat-up may occur over a time period of up to 30 seconds, suitably of up to 20 seconds, currently preferred of up to 10 seconds, in particular of up to 5 seconds. The short heat-up phase for reaching the heat-up temperature is, in combination with a subsequent holding phase, particularly advantageous for the process reliability of the produced component.

According to another advantageous feature of the present invention, the holding time may extend over a time period of up to 30 seconds. Advantageously, the holding time extends over a time period of up to 20 seconds, currently preferred of up to 10 seconds, in particular of up to 5 seconds. Within the context of the invention, the hardening and tempering process can be particularly reliably performed by intentionally controlling the material structure transformation at a constant temperature and is only affected by the duration of the holding time. The attained heat-up temperature is held substantially constant.

According to another advantageous feature of the present invention, the first cooldown phase may have a longer duration than the second cooldown phase. This is particularly advantageous for the material structure to be produced and for the related processing steps. The transmission tunnel according to the invention can be post-processed immediately following processing. It is therefore feasible within the context of the invention that the heat-treated regions as well as the transmission tunnel have a component temperature of 200° C. when transferred to a post-processing process.

Moreover, the second phase may advantageously be performed in a time period of up to 120 seconds, suitably of up to 60 seconds.

In the context of the invention, a transmission tunnel also refers to an assembled transmission tunnel. The transmission tunnel here consists of at least one hot-formed and press-hardened steel component which after press-hardening is sold-wise heat-treated at least in one region, coupled with various other components. Partial heat treatments of the other components may possibly have also been performed after press-hardening; alternatively, untreated sheet steel components may also be considered for coupling. Additionally, for example milled components or fiber composite components may be suitably within the context of the invention for coupling with a hot-formed and press-hardened transmission tunnel that is partially heat-treated after press-hardening.

If coupling with other sheet steel components is contemplated, the transmission tunnel according to the invention may also be partially heat-treated in the coupling regions of the coupling. This provides similar advantages as a non-piece transmission tunnel of the type described above.

According to another advantageous feature of the present invention, the floor group is characterized in that the coupling regions between transmission tunnel and component may be, after coupling, heat-treated at least in zones.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a detail of a transmission tunnel according to the invention;

FIG. 2 shows a transmission tunnel of an unillustrated motor vehicle;

FIG. 3 shows a floor assembly according to the invention with a centrally arranged transmission tunnel;

FIG. 4 shows an assembled transmission tunnel;

FIG. 5 shows another perspective view of a transmission tunnel from below; and

FIGS. 6a), b), c) show different temperature curves during manufacture of a transmission tunnel.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

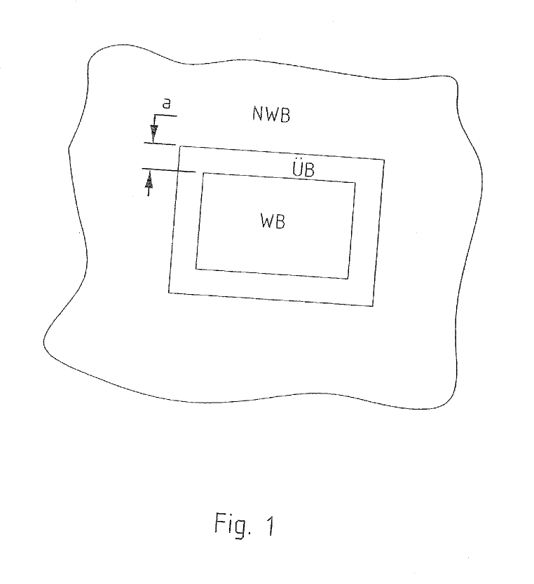

Turning now to the drawing, and in particular to FIG. 1, there is shown a detail of a transmission tunnel. As can be seen, a heat-treated region WB is according to the present invention formed in a non-heat-treated region NWB. A transition zone UB is disposed between the non-heat-treated region NWB and the heat-treated region WB. A material structure having the tendency to be ductile is created in the heat-treated region WB, whereas the material structure in the non-heat-treated region NWB is hard and brittle. The transition zone UB is inherently created during treatment of the heat-treated region WB. In the context of the present invention, the transition zone UB has essentially a width a, which extends from the heat-treated region WB to the non-heat-treated region NWB, which is particularly small in relation to the heat-treated region WB and which has substantially sharp edges.

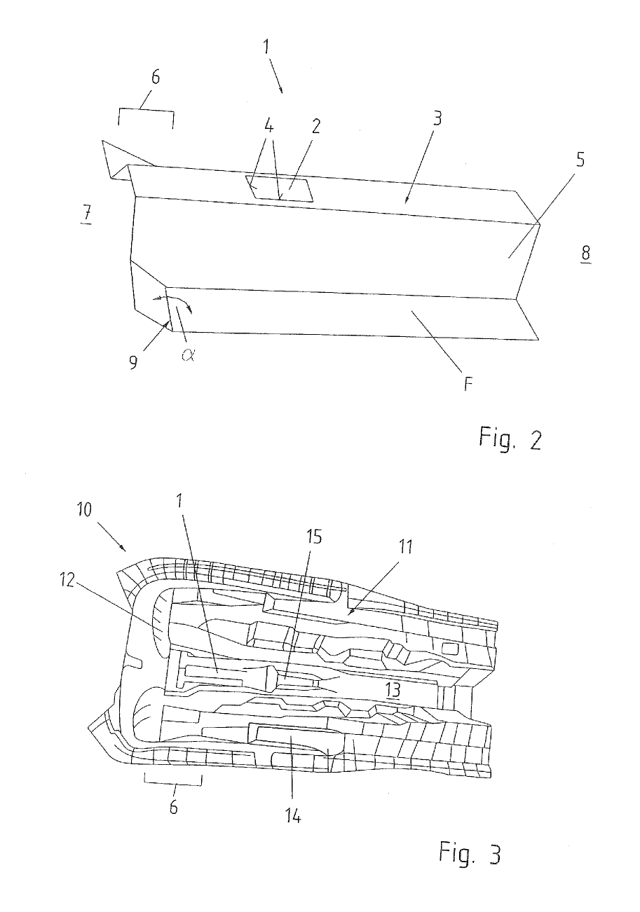

FIG. 2 shows a transmission tunnel 1 of an unillustrated motor vehicle. The transmission tunnel 1 has and opening 2 disposed on its upper center section 3. The marginal regions 4 of the opening 2 in the transmission tunnel 1 according to the invention are partially heat-treated, thereby reducing existing surface stress.

The transmission tunnel 1 according to the invention also has joining flanges F extending along its sides. The joining flanges F can hereby, as illustrated, adapted in a front section 6 of the transmission tunnel 1 to the geometric features for coupling with an unillustrated floor group. As illustrated, the front part 7 of the joining flange F is arranged at an angle α relative to the rear part 8 of the joining flange F. The transition segment 9 from the front to the rear part 7, 8 is according to the invention partially heat-treated. Conversely, the front part 7 of the joining flange F is still in the material state attained after press-hardening, to prevent unillustrated engine components from entering or penetrating the passenger compartment.

FIG. 3 shows a floor arrangement 10 according to the invention with a centrally arranged transmission tunnel 1. Floor panels 11 are coupled to corresponding sides 5 of the transmission tunnel 1. A splash guard 12 is arranged in the front section 6 of the transmission tunnel 1 which separates the passenger compartment 13 from the unillustrated drive components. The number of recesses 14, beads 15 and openings are arranged in the transmission tunnel 1 itself as well as in the floor panels 11. According to the invention, these regions are also partially heat-treated, thereby providing an optimized crash response of the motor vehicle with the overall design of the floor group 10. This simultaneously produces a high deformation stiffness of the passenger compartment, while also being able to absorb energy by converting kinetic crash energy into deformation energy.

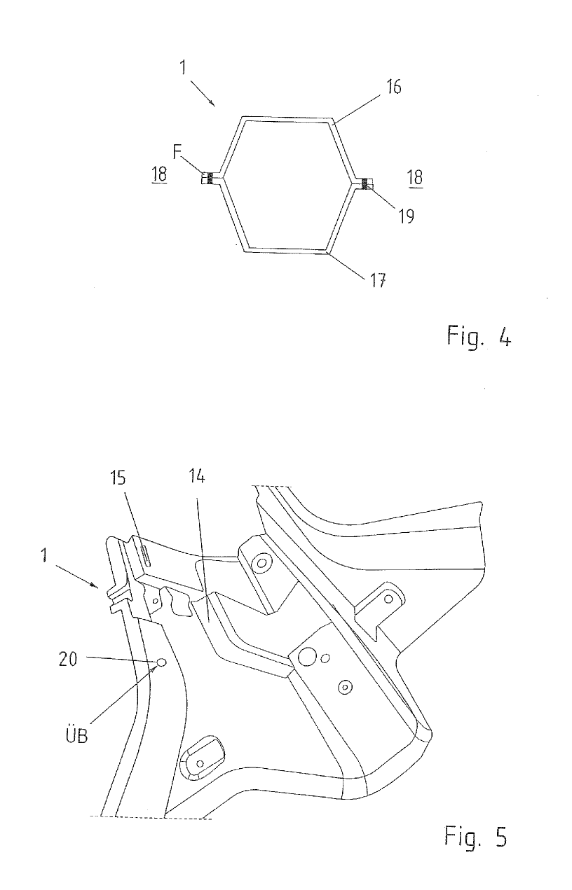

FIG. 4 shows an assembled transmission tunnel 1. The transmission tunnel 1 includes an upper hot-formed, press-hardened component 16 which is partially heat-treated after press-hardening, and a lower hot-formed, press-hardened component 17 which is also partially heat-treated after press-hardening. The upper component 16 and lower component 17 have each joining flanges F disposed at the respective side regions 18. These joining flanges F are coupled with each other via a coupling process. The coupling locations 19 are according to the invention partially heat-treated after the joining process, for example a formal joining process.

FIG. 5 shows another perspective view of a transmission tunnel 1 from below. This embodiment of the transmission tunnel 1 has a number of recesses 14, beads 15 and openings, which are partially heat-treated in their regions or in the surrounding regions. Moreover, the transmission tunnel 1 in FIG. 5 has spot-shaped heat treatment zones 20 which according to the invention are heat-treated after press-hardening end have only a narrow transition zone UB to the press-hardened regions.

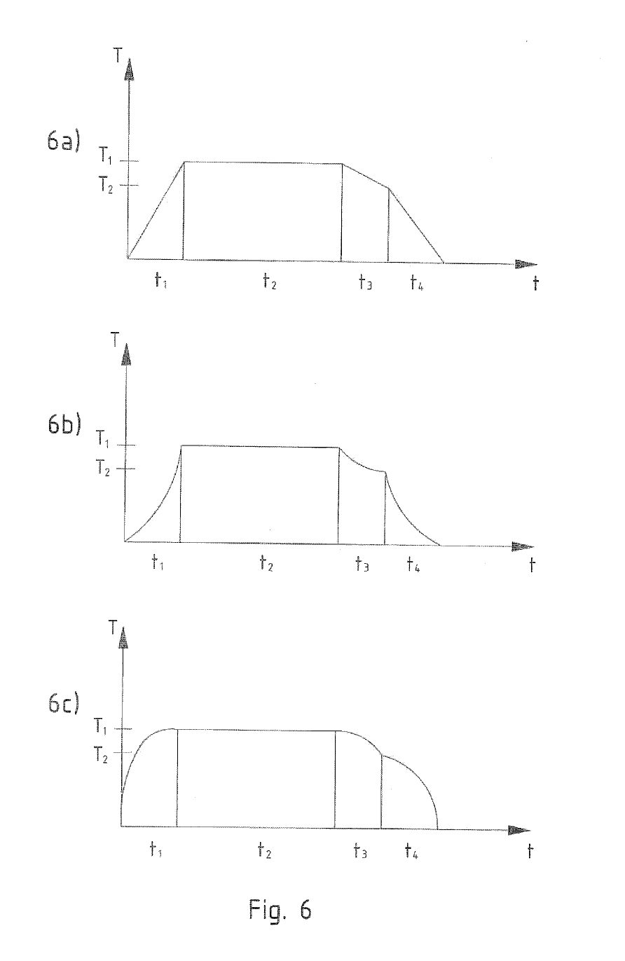

FIG. 6a shows a temperature curve as a function of time, with the time intervals heat-up time (t1), holding time (t2), cooldown time first phase (t3) and cooldown time second phase (t4). Also shown on the temperature axis are the heat-up temperature (T1) and a first cooldown temperature (T2).

Starting with a blank of sheet steel which is hot-formed and press-hardened to produce a transmission tunnel which is essentially at a temperature below 200° C., this vehicle component is heated during the heat-up time to the heat-up temperature (T1). With a starting temperature of below 200° C., but still above room temperature, the residual thermal energy from the hot-forming and press-hardening process is used for the partial heat treatment within the context of the invention.

Heat-up includes a linear temperature increase as a function of time. After the heat-up time (t1), the heat-up temperature (T1) is maintained during a holding time (t2). The heat-up temperature (T1) is held essentially constant during the entire holding time (t2). Temperature variations in form of a temperature increase or a temperature decrease are not illustrated, but may be implemented within the context of the invention during the holding time (t2) to affect the desired changes in the material structure, but also for cost reasons of the production process.

At the end of the holding time (t2), a first cooldown to a cooldown temperature (T2) occurs. The temperature hereby decreases linearly during the cooldown time of the first phase (t3) to the cooldown temperature (T2). The cooldown temperature (T2) may be in a range between 100° C. and the heat-up temperature (T1).

In a subsequent second cooldown phase, an additional linear temperature decrease takes place during the cooldown time of the second phase (t4). The temperature can hereby essentially be lowered to room temperature or to a desired (unillustrated) target temperature. It would also be feasible within the context of the invention to include additional cooldown phases, which are not illustrated.

FIG. 6b shows a substantially similar temporal arrangement of the heat treatment, with the difference to FIG. 6a that the temperature increases progressively during the heat-up time (t1), whereas the temperature steadily decreases with time (t3, t4) during the first and second phase of the cooldown.

FIG. 6c shows, in addition to FIGS. 6a and 6b, that the temperature curve has a diminishing temperature increase during the heat-up time (t1) and that the functional dependence of the temperature decrease over time (t3, t4) is progressive during each of the various cooldown phases.

In the context of the invention, it would also be feasible to combine the temperature dependence over time in mixed forms, such as progressive, linear and diminishing, and to realize a temperature change with progressive, diminishing or linear functional dependence during the holding time (t2).

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A transmission tunnel made of a sheet steel, said transmission tunnel having a first region which underwent heat treatment, a second region which is not heat-treated, and a transition zone between the first and second regions, said transition zone defined by a width which is smaller than or equal to 50 mm.

2. The transmission tunnel of claim 1 for installation in a motor vehicle body.

3. The transmission tunnel of claim 1, said transmission tunnel produced by hot-forming and press-hardening of a steel sheet blank, said first region undergoing heat treatment after press-hardening.

4. The transmission tunnel of claim 1, wherein the width of the transition zone is less than 30 mm.

5. The transmission tunnel of claim 1, wherein the width of the transition zone is less than 20 mm.

6. The transmission tunnel of claim 1, wherein the width of the transition zone corresponds to 0.2 times to 3.0 times a width and/or height of the first region.

7. The transmission tunnel of claim 1, said transmission tunnel comprising joining flanges having at least one area which is heat-treated.

8. The transmission tunnel of claim 1, said transmission tunnel comprising openings having at least one area which is heat-treated.

9. The transmission tunnel of claim 1, said transmission tunnel comprising recesses having at least one area which is heat-treated.

10. The transmission tunnel of claim 1, wherein the first region of the transmission tunnel is an end region, said transmission tunnel having a joining flange arranged on the end region and constituting the second region.

11. The transmission tunnel of claim 1, wherein the first region has spot-shaped zones defined by a size which is less than 50 mm.

12. The transmission tunnel of claim 1, wherein the first region has spot-shaped zones defined by a size which is less than 30 mm.

13. The transmission tunnel of claim 1, wherein the first region is defined by a yield strength between 300 N/mm² and 1300 N/mm².

14. The transmission tunnel of claim 1, wherein the first region is defined by a yield strength from 400 N/mm² to 800 N/mm².

15. The transmission tunnel of claim 1, wherein the first region is defined by a yield strength from 400 N/mm² to 600 N/mm².

16. The transmission tunnel of claim 1, wherein the first region is defined by a tensile strength between 400 N/mm² and 1600 N/mm².

17. The transmission tunnel of claim 1, wherein the first region is defined by a tensile strength from 500 N/mm² to 1000 N/mm².

18. The transmission tunnel of claim 1, wherein the first region is defined by a tensile strength from 550 N/mm² to 800 N/mm².

19. The transmission tunnel of claim 1, wherein the first region is defined by a ductility between 10% and 20%.

20. The transmission tunnel of claim 1, wherein the first region is defined by a ductility from 14% to 20%.

21. The transmission tunnel of claim 1, wherein the transition zone is defined by a yield strength and/or tensile strength decreasing with a gradient of more than 100 N/mm² per 1 cm.

22. The transmission tunnel of claim 1, wherein the transition zone is defined by a yield strength and/or tensile strength decreasing with a gradient of more than 200 N/mm² per 1 cm.

23. The transmission tunnel of claim 1, wherein the transition zone is defined by a yield strength and/or tensile strength decreasing with a gradient of more than 400 N/mm² per 1 cm.

24. The transmission tunnel of claim 3, wherein the heat treatment of the first region includes heating to a heat-up temperature, holding the heat-up temperature during a holding time, and cooling down from the heat-up temperature in at least two phases.

25. The transmission tunnel of claim 24, wherein the heat-up temperature ranges between 500° C. and 900° C.

26. The transmission tunnel of claim 24, wherein the first region is heated to the heat-up temperature at a time interval of up to 30 seconds.

27. The transmission tunnel of claim 24, wherein the first region is heated to the heat-up temperature at a time interval of up to 20 seconds.

28. The transmission tunnel of claim 24, wherein the first region is heated to the heat-up temperature at a time interval of up to 10 seconds.

29. The transmission tunnel of claim 24, wherein the first region is heated to the heat-up temperature at a time interval of up to 5 seconds.

30. The transmission tunnel of claim 24, wherein the holding time is up to 30 seconds.

31. The transmission tunnel of claim 24, wherein the holding time is up to 20 seconds.

32. The transmission tunnel of claim 24, wherein the holding time is up to 10 seconds.

33. The transmission tunnel of claim 24, wherein the holding time is up to 5 seconds.

34. The transmission tunnel of claim 24, wherein a first phase of the two cooldown phases has a duration which is longer than a duration of a second phase of the two cooldown phases.

35. The transmission tunnel of claim 34, wherein the duration of the second phase is up to 120 seconds.

36. The transmission tunnel of claim 34, wherein the duration of the second phase is up to 60 seconds.

37. A floor assembly for a motor vehicle, comprising:
a transmission tunnel made of a sheet steel blank and having a first region which underwent heat treatment, a second region which is not heat-treated, and a transition zone between the first and second regions, said transition zone defined by a width which is smaller than or equal to 50 mm, and
at least one component coupled to the transmission tunnel.

38. The floor assembly of claim 37, wherein a coupling region between the transmission tunnel and the at least one component has at least one area which is heat-treated after coupling.
